(19) United States
(12) Patent Application Publication
(10) Pub. No.: US 2021/0225554 A1
(43) Pub. Date: Jul. 22, 2021

(54) HIGH-VOLTAGE FEEDTHROUGH AND METHOD FOR THE PRODUCTION THEREOF

(71) Applicant: Siemens Aktiengesellschaft, Muenchen (DE)

(72) Inventor: Achim LANGENS, Lohmar (DE)

(21) Appl. No.: 17/154,091

(22) Filed: Jan. 21, 2021

(30) Foreign Application Priority Data
Jan. 21, 2020 (DE) 10 2020 200 662.8

(51) Int. Cl. H01B 3/50; H01B 17/26; H01B 19/04

(52) U.S. Cl. CPC H01B 3/50; H01B 19/04; H01B 17/26

(57) ABSTRACT

A high-voltage bushing has an inner conductor which is led through an insulator. The inner conductor has insulating layers which incorporate a plastic fabric. The plastic fabric contains aramid fibers. A method for producing the high-voltage bushing includes winding insulating layers formed from a plastic fabric having aramid fibers onto a winding core to form an insulator.

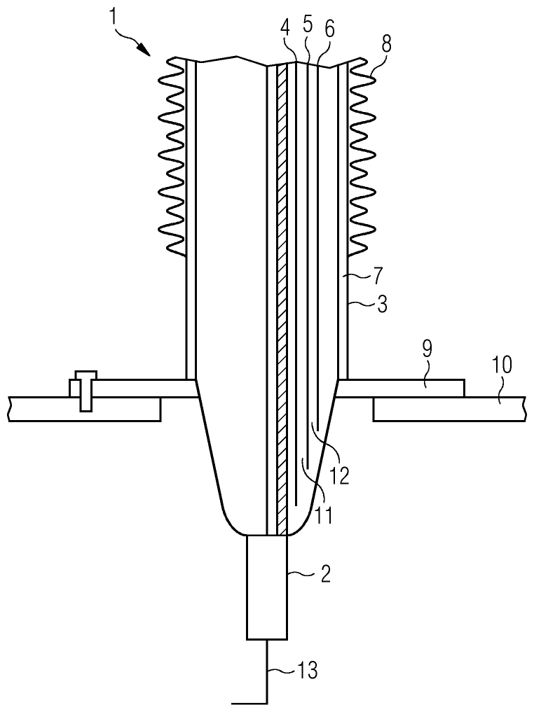

### CROSS-REFERENCE TO RELATED APPLICATION

This application claims the priority, under 35 U.S.C. § 119, of German application DE 10 2020 200 662.8, filed Jan. 21, 2020; the prior application is herewith incorporated by reference in its entirety.

### BACKGROUND OF THE INVENTION

### Field of the Invention

The invention relates to a high-voltage bushing having an inner conductor which is led through an insulator, wherein the inner conductor has insulating layers which incorporate a plastic fabric.

A high-voltage bushing of this type, i.e. a bushing which is rated for the insulation of a voltage of at least 100 kV, is known from international patent disclosure WO 2019/011426 A1, corresponding to U.S. patent publication No. 2020/0168370. The function of the high-voltage bushing is to insulate the inner conductor which, in the operation of the high-voltage bushing, lies at a high-voltage potential, from a surrounding environment at ground potential, for example a wall of a high-voltage installation. The plastic fabric, for example, can be formed of, or can incorporate, fibers or filaments of an arbitrary, in particular finite, length. It is also conceivable for the fabric to contain “endless filaments”. The term “endless filaments” describes fibers of an unlimited length. The plastic fabric can, for example, be a synthetic plastic fabric. A plastic fabric is characterized by plastic fibers which form the fabric material. The use of plastic fabric has the particular advantage over the use of paper that plastic fabrics having moisture-repellent properties can be used.

On account of the relatively high current which flows through the inner conductor during the operation of the bushing, it is also customary for a rise in temperature to occur in the insulator. For this reason, a maximum permissible service temperature must also be considered in the design of the high-voltage bushing.

### BRIEF SUMMARY OF THE INVENTION

The object of the invention is to disclose a generic high-voltage bushing which can be used in the most reliable and versatile manner possible.

This object is achieved in a generic high-voltage bushing according to the invention in that the plastic fabric contains fibers of an aramid, wherein the aramid fibers preferably constitute a proportion by weight of the fabric in excess of 90%. In the context of the present invention, an aramid is an aromatic polyimide.

According to the applicant's own findings, in the operation of the high-voltage bushing, power spikes occur in the context of dynamic network loading which can result in a partial electrical and thermal overloading of the high-voltage bushing. The use of aramid fibers can advantageously allow the high-voltage bushing to be operated reliably at relatively high temperatures, for example temperatures in excess of 120° C. In particular, the risk of significantly accelerating the ageing of the bushing or of a potential outage is reduced accordingly. Moreover, it is not necessary for the high-voltage bushing to be embodied with larger dimensions, in particular with respect to the diameter of the inner conductor, in order to reduce the thermal loading of the high-voltage bushing (according to the effect whereby a larger inner conductor diameter is associated with a lower electrical resistance, and thus with lower ohmic thermal losses). This circumstance, in turn, gives rise to a cost benefit. In the context of the invention, aramids which do not melt at high temperatures, but rather only begin to carbonize at temperatures in excess of approximately 400° C., are expediently to be used. By means of such aramids, the high-voltage bushing can be operated at a temperature in excess of 120° C., preferably at a temperature in excess of 180° C.

The insulator of the high-voltage bushing is preferably impregnated with a resin. The insulator can be produced, for example, by winding the insulating layers about a winding support (which can also be the inner conductor, but does not have to be) and subsequent impregnation with resin. In this manner, a winding is produced which possesses sufficiently good mechanical and insulating properties for high-voltage operation.

The resin is preferably a high-temperature resin (“high TG resin”). High-temperature resins are known from the prior art. They do not melt, and do not undergo any breakdown, even at service temperatures in excess of 200° C., such that the use of the high-temperature resin in conjunction with an aramid fabric is particularly advantageous. The resin can expediently be an epoxy resin.

According to one embodiment of the invention, the insulator contains concentrically arranged, conductive control inserts for field control, in particular capacitive field control. The function of the control inserts is the capacitive field control of the electric field of the high-voltage bushing during the operation thereof. Consequently, this gives rise to a further improvement of the electrical properties of the high-voltage bushing. The control inserts are arranged concentrically with respect to one another about the inner conductor. They can be produced, for example, in the form of aluminum foils.

As already described above, the insulating layers can be wound concentrically or spirally about the inner conductor to form a winding. In this manner, production of the bushing can be executed in a particularly simple and cost-effective manner. Moreover, a particularly uniform arrangement of the insulating layers in the insulator can be ensured. A uniform arrangement of the insulating layers is of particular importance, in particular in conjunction with control inserts, since the uniformity (or evenness) of the control inserts is associated with the evenness of the insulating layers. Uneven control inserts, in turn, impair the dielectric properties of the high-voltage bushing.

It is considered to be particularly advantageous if the resin incorporates a filler. The filler can in particular be formed by solid elements or particles. The use of the filler advantageously influences the physical properties of the insulating system of the high-volage bushing, and moreover generates a significant cost benefit, in comparison with filler-free systems. The high-voltage bushing is preferably rated for the insulation of a service voltage in excess of 100 kV. To this end, the high-voltage bushing in particular has a length in excess of 5 m. In solid high-voltage bushings which are configured to this size, the use of fillers is particularly advantageous since they support or ensure mechanical stability.

The invention further relates to a method for producing a high-voltage bushing.

The object of the invention is to disclose such a method, which permits the production of a high-voltage bushing which is as reliable as possible and as versatile as possible in its application.

This object is achieved according to the invention by a generic method, wherein insulating layers of a fabric, which contains aramid fibers, are wound onto a winding core to form an insulator, and the insulator is impregnated with a resin, preferably a high-temperature resin.

The advantages of the method according to the invention proceed specifically from the advantages described above with reference to the high-voltage bushing according to the invention.

Other features which are considered as characteristic for the invention are set forth in the appended claims.

Although the invention is illustrated and described herein as embodied in a high-voltage feedthrough and a method for the production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE is a schematic representation of an exemplary embodiment of a high-voltage bushing according to the invention.

### DETAILED DESCRIPTION OF THE INVENTION

Referring now to the single FIGURE of the invention, there is shown a high-voltage bushing 1. The high-voltage bushing 1 contains an inner conductor 2, which is led through an insulator 3. The inner conductor 2 is configured in the form of a hollow conductor of aluminum or copper. The high-voltage bushing 1 contains a housing 7 and shields 8 of silicone, which are mounted on the exterior of the housing 7. A mounting flange 9 which serves for mounting the high-voltage bushing 1 on a wall 10, for example of a transformer tank, is also provided.

The insulator 3 contains conductive control inserts 4-6 for capacitive field control, which are arranged concentrically about the inner conductor 3. The control inserts 4-6 are separated from one another by wound insulating layers 11, 12. Each insulating layer 11 or 12 is comprised of a plurality of insulating layers of an aramid fabric which, after being wound about the inner conductor 2, have been impregnated with resin. The resin is a high-temperature resin, which is an epoxy resin.

The high-voltage bushing 1 represented in the FIGURE has an overall length of 12 m and is used for the insulation of a service voltage in excess of 300 kV.

For the production of the high-voltage bushing 1, the inner conductor 2 is provided as a winding core. The insulating layers of the aramid fabric are wound about the inner conductor 2 winding core to form the insulator 3. The insulator is then impregnated with the high-temperature resin. The solid block obtained in this manner is arranged in the housing 7, wherein a secondary insulation, for example in the form of an insulating gas and/or a dry foam, is arranged between the insulator 3 and the housing 7.

A high-voltage transformer can be provided, in which the high-voltage bushing 1 is mounted on the wall 10 of a transformer tank such that a transformer winding 13 of the high-voltage transformer is brought out of the transformer tank, in an insulated arrangement, by means of the high-voltage bushing 1.

1. A high-voltage bushing, comprising:
an insulator having insulating layers formed of a plastic fabric containing aramid fibers; and
an inner conductor led through said insulator.

2. The high-voltage bushing according to claim 1, wherein said insulator is impregnated with a resin.

3. The high-voltage bushing according to claim 2, wherein said resin is a high-temperature resin.

4. The high-voltage bushing according to claim 2, wherein said resin is an epoxy resin.

5. The high-voltage bushing according to claim 1, wherein said insulator has concentrically disposed, conductive control inserts for field control.

6. The high-voltage bushing according to claim 1, wherein said insulating layers are concentrically or spirally wound about said inner conductor to form a winding.

7. The high-voltage bushing according to claim 2, wherein said resin has a filler.

8. The high-voltage bushing according to claim 7, wherein said filler is formed from solid particles.

9. The high-voltage bushing according to claim 1, wherein the high-voltage bushing is rated for insulation of a service voltage in excess of 100 kV.

10. A method for producing a high-voltage bushing, which comprises the steps of:
winding insulating layers formed from a plastic fabric having aramid fibers onto a winding core to form an insulator; and
impregnating the insulator with a resin.

11. The method according to claim 10, wherein the resin is a high-temperature resin.
